(19) United States
(12) Patent Application Publication
(10) Pub. No.: US 2025/0065163 A1
(43) Pub. Date: Feb. 27, 2025

(54) FOAM ASPIRATION NOZZLE

(71) Applicant: Rely Innovations, Inc., Eau Claire, WI (US)

(72) Inventors: J.R. Nerat, Wallace, MI (US); Seth Rooney, Eau Claire, WI (US)

(21) Appl. No.: 18/811,516

(22) Filed: Nov. 18, 2024

Related U.S. Application Data
(60) Provisional application No. 63/533,798, filed on Aug. 21, 2023.

(51) Int. Cl. A62C 5/02

(52) U.S. Cl. CPC A62C 5/024

(57) ABSTRACT

A foam aspiration nozzle for use with fire extinguishers. The foam aspiration nozzle includes a discharge tube having air inlets that are partially protected by a shield to prevent blockage, the shield having an open end to allow the entry of air. The foam aspiration nozzle also includes a spray flange which is configured with spray orifices that direct a water and foaming agent into the discharge tube where the water and foaming agent is mixed with air from the air inlets. The result of spraying the water and foaming agent such that air is introduced to the mixture is the production of foam which is expelled from the discharge tube for application to a burning substance to extinguish flames emanating from the substance.

### TECHNICAL FIELD

The present invention is directed to the field of fire suppression devices. More specifically, the present invention is directed to a nozzle portion for use in foam-type portable fire extinguishers.

### BACKGROUND

There are several types of portable fire extinguishers in use. One of the more common variety being stored pressure extinguishers. While other types of extinguishers utilize gas cartridges which when released pressurize a chamber comprising a fire suppressant. Regardless of whether from a stored pressure or cartridge-type pressure source, the pressure is used to expel a suppressant from a storage chamber through an exit to extinguish a flame. Stored pressure-type extinguishers generally comprise a single chamber that is partially filled with a suppressant material and pressurized using air, carbon dioxide, or other gas. The extinguisher is then stored in a pressurized state until needed to extinguish a fire. The suppressant used in a stored pressure extinguisher can be liquids, dry powders, or foams. Liquid and chemical suppressants can be very effective for certain types of fires, but foams are generally preferred when the source of the fire to be suppressed is a flammable liquid such as gasoline or oil. Foams are often formed using foaming agents mixed with water with the mixture being expelled from a fire extinguisher. The introduction of air (aspiration) during the expulsion of the foaming agent/water mixture from the extinguisher causes the foaming agent to expand into a foam that serves to cover and smother burning liquids and other materials, thereby extinguishing the flame. Environmental concerns have caused the chemical composition of foaming agents to change from aqueous film-forming foams (AFFF) to non-AFFF foams. The change to non-AFFF foaming agent compounds has changed the foaming characteristics such that existing extinguisher nozzles are not well suited to produce foams from non-AFFF foaming agents that exhibit fire suppressant characteristics as effective as the previous AFFF compounds when dispensed by such nozzles. What is needed is a foam aspiration nozzle that is able to produce a foam from a non-AFFF foaming agent water mixture that is as effective or more effective than previous AFFF compounds.

### SUMMARY

Embodiments relate to foam aspiration nozzles configured to introduce air into a mixture of water and foaming agent that is being provided to the nozzle from a pressurized storage tank. More specifically, exemplary embodiments of foam aspiration nozzles include a barb portion for connection to a supply hose, an inlet tube, the inlet tube in fluid communication with a plurality of outlet orifices, an outlet recess, a threaded collar, a stop flange, an extension shoulder, a wand portion which comprises a threaded receiver at a first end of a tubular shaft, a plurality of air inlets positioned along the shaft adjacent to the first end, an outlet at a second end of the tubular shaft, and a guard collar portion. The guard collar portion comprising a base portion at a first end, a side wall portion forming the body of the guard collar, and an inlet portion at a second end, the base portion comprising an opening through which the barb portion passes such that when the threaded collar is affixed to the threaded receiver, the body of the guard collar coaxially surrounds the plurality of air inlets preventing the blockage of those air inlets located along the tubular shaft.

In another exemplary embodiment, a spray flange comprises a barbed portion, a threaded collar, an inlet, a plurality of outlet orifices in fluid communication with the inlet, each of the plurality of the outlet orifices arranged about a central axis of the spray flange and further arranged such that the axis of each outlet orifice is tilted such that each axis of the plurality of outlet orifices converge at a point along a line forming the central axis of the spray flange, an angle of tilt being between 30 and 50 degrees toward the central axis of the spray flange.

The above summary is not intended to describe each illustrated embodiment or every implementation of the invention. Rather, the exemplary embodiments are chosen and described so as to provide an overview or framework for understanding the nature and character of the claimed aspects and implementations so that those skilled in the art can appreciate and understand the principles and practices of the invention. The Figures and the detailed description that follow more particularly exemplify these exemplary embodiments and are incorporated in and constitute a part of this specification.

### BRIEF DESCRIPTION OF THE DRAWINGS

These and other features and advantages of the present invention will become better understood with regard to the following description and accompanying drawings in which:

FIG. 1 is a diagram of a fire extinguisher discharge hose including a foam aspiration nozzle according to an exemplary embodiment;

FIG. 1A is a cross-section view of the fire extinguisher discharge hose of FIG. 1;

FIG. 2 is an exploded view of the fire extinguisher discharge hose of FIG. 1;

FIG. 3 is an enlarged view of an inlet portion of a foam aspiration nozzle according to an exemplary embodiment;

FIG. 4 is a side view of a spray flange portion of a foam aspiration nozzle according to an exemplary embodiment;

FIG. 4A is an end view of the spray flange of FIG. 4;

FIG. 4B is a cross-section view of the spray flange of FIG. 4; and

FIG. 5 is an enlarged view of an orifice portion of a spray flange according to an exemplary embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

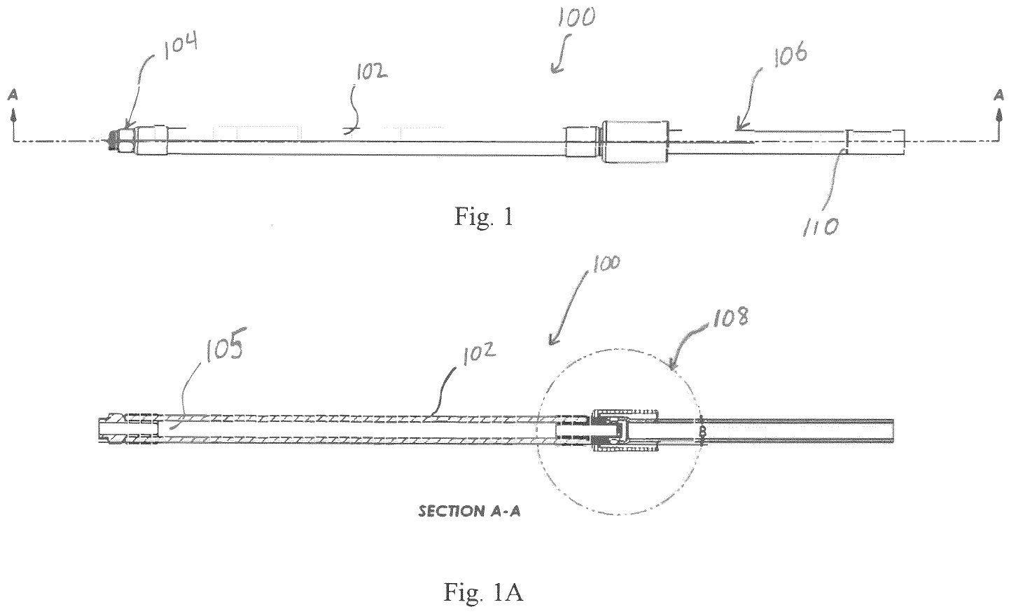

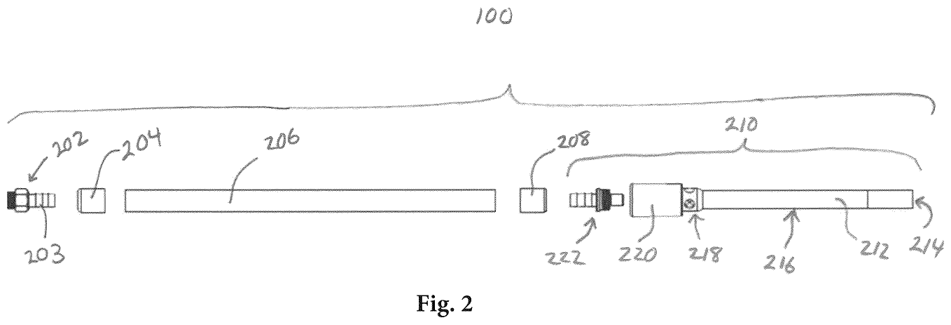

FIG. 1 illustrates an exemplary embodiment of a foam aspiration nozzle assembly 100 configured with a flexible hose portion 102, an inlet fitting 104, and a nozzle portion 106. FIG. 2 illustrates an exploded view of the foam aspiration nozzle assembly 100 such that the individual components are more easily discernable. As shown in FIG. 2, the assembly comprises a fitting 202 which includes threads or some other method of connecting the assembly 100 to a fire extinguisher pressure tank and valve (not illustrated). The fitting 202 comprises a barbed portion 203 which is affixed to a first end of a flexible hose 206 using a first clamping band 204 applied such that the clamping band 204 compresses the first end of the flexible hose 206 such that the first end is compressed against the barbed portion 203 of the fitting 202 to secure the fitting 202 to the flexible hose 206 when pressure or other strain is applied to the flexible hose 206. The second end of the flexible hose 206 is connected to the foam aspiration nozzle assembly 210 using a second clamping band 208 in a manner similar to that employed with the fitting 202 and first clamping band 204. When in use, a valve connected between pressurized storage chamber and the foam aspiration nozzle assembly is opened such that a water and foaming agent mixture is allowed to flow from pressurized storage chamber through the valve, the fitting 202, and hose 206 to the foam aspiration nozzle assembly 210. The cross-section view 102 of the hose assembly 100 found in FIG. 1A illustrates a passage 105 that extends from fitting 202 to the foam aspiration nozzle assembly 210. Exemplary embodiments may also be formed using a rigid pipe or other fluid transfer body rather than the flexible hose 206 illustrated. For example, certain embodiments may not utilize a hose at all and may instead connect directly to a valve, a fluid pathway formed in a fire extinguisher, a piping system, or other methods of distributing water and a foaming agent. In certain exemplary embodiments, water may be in a first chamber while a foaming agent may be stored in a separate chamber and mixed as they pass through a valve assembly. However, most embodiments will comprise a pressurized container that holds water and foaming agent together. Certain exemplary embodiments may comprise a pump that causes the water/foaming agent mixture to flow through the foam aspiration nozzle assembly 100 rather than relying on stored pressure.

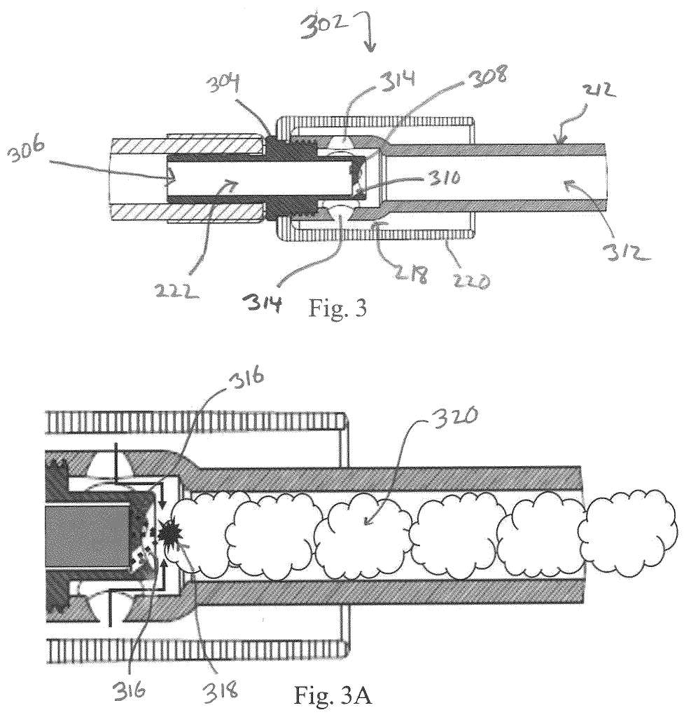

FIG. 3 shows an enlarged view 302 of an inlet portion of the foam aspiration nozzle assembly 210 as indicated by circle 108 of FIG. 1A. Referring FIGS. 2 and 3, the foam aspiration nozzle 210 is illustrated in an exploded view such that the individual components are visible. As shown, the foam aspiration nozzle assembly 210 comprises a discharge tube 212 which has an exit end 214, a shaft portion 216, and an air intake portion 218. The air intake portion 218 comprises a plurality of openings 314 spaced radially about the air intake portion 218. As shown, the openings 314 may be chamfered such that the diameter of the openings 314 at an inner surface of the discharge tube 212 is larger than the diameter of the openings 314 at an outer surface of the discharge tube 212. This chamfer helps to reduce any restriction to airflow caused by the narrow space between the spray flange 222 and the discharge tube 212. As illustrated in FIG. 3, in certain exemplary embodiments the air intake portion 218 of the discharge tube 212 may be flared to allow for more space between the spray flange 222 and the air intake portion 218. Alternatively in certain exemplary embodiments, a discharge tube 212 with a thicker wall cross-section may be processed to reduce the thickness of the wall in the area of the air intake portion 218 to provide a similar amount of additional space between the inner wall of the discharge tube 212 and the spray flange 222.

As is shown in at least FIG. 3, an embodiment of the foam aspiration nozzle assembly 210 also comprises a shield 220 which serves to prevent a user's hand from blocking the air intake portion 218 of the discharge tube 212. The shield 220 is shown installed between the spray flange 222 and the air intake portion 218 of the discharge tube 212 (only partially shown). A step portion 304 formed in the spray flange 222 serves to capture the shield 220 between the spray flange 222 and the air intake portion 218. In the illustrated embodiment, the spray flange 222 is configured with a threaded portion that engages with matching threads formed in the air intake portion 218 of the discharge tube 212.

When in use, exemplary embodiments allow passage of a mixture of water and a foaming agent through a passage 306 formed in the spray flange 222. When the mixture reaches the end of the spray flange 308, it is forced through a plurality of orifices 310 (one of which is illustrated) and enters the inner portion 312 of the discharge tube 212. As the mixture enters the inner portion 312, it draws air into the plurality of openings 314 formed in the air intake portion 218 of the discharge tube 212. This intake of air combines with the mixture to form a foam which passes through the inner portion 312 of the discharge tube 212 to the exit end 214 whereupon the foam may be directed to cover and extinguish the source of a fire.

A sufficient amount of air is required to be introduced to the water/foaming agent mixture to form foam with optimal fire suppression characteristics. For example, with enough air mixed into the foam to create a lofted foam that settles onto the surface of a burning liquid to prevent air from reaching the fire, thus extinguishing the flames. As is illustrated in FIG. 3A, this is achieved by spraying a plurality of streams 316 of water/foaming agent mixture from the plurality of orifices 310 of the spray flange 308 such that the streams converge 318 at a point in the inner portion 312 of the discharge tube 212. The convergence serves to disrupt the steady flow of the water/foaming agent mixture, scattering the streams to expose more of the water/foaming agent mixture in the form of droplets or spatter. This disruption causes air from the openings 314 to be drawn into the mixture past the point of convergence 318. The result is an expansion into foam 320. The continuous introduction of water/foaming agent mixture pushes the produced foam 320 such that it travels through the inner portion 312 of the discharge tube 212 until it exits the discharge tube in the form of a steady stream of foam.

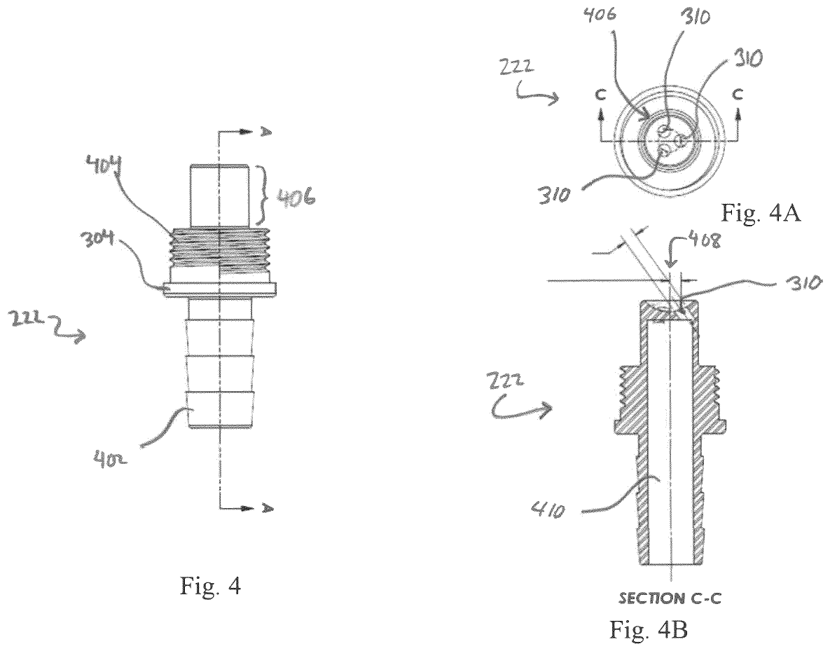

FIG. 4 illustrates a side view of the spray flange 222 showing the inlet barb 402, the step portion 304, and the threaded portion 404. Adjacent to the threaded portion 404 is extension 406 comprising the plurality of orifices 310. The extension 406 serves to position the plurality of orifices 310 such that the convergence 318 of the streams is located at a point relative to the openings 314 which optimizes the combination of air with the water/foaming agent mixture for optimal fire suppressive performance. FIG. 4A illustrates an exemplary embodiment of the orifices of the spray flange 222. As shown, in the exemplary embodiment, there are three orifices 310 positioned in extension 406.

FIG. 4B is a cross-section of the spray flange 222. Visible is one of the plurality of orifices 310, which is angled toward an axial center point 408. Although not shown, the remainder of the plurality of orifices are also angled toward the axial center point 408. As shown in the exemplary embodiment of FIG. 4B, a passage 410 is formed in the spray flange 222 that extends from a first end adjacent to the inlet barb 402 to the extension 406 portion allowing fluid communication from the passage 410 to the plurality of orifices 310.

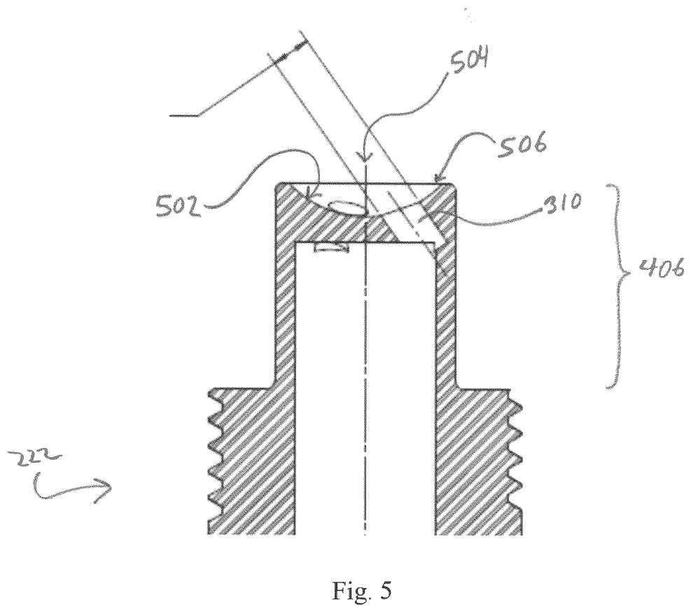

As is visible in the enlarged view of FIG. 5, a concave surface 502 is formed in the end of the spray flange 222 to permit the convergence of streams exiting the plurality of orifices 310 to occur in open air rather than at a surface of the spray flange 222. Certain exemplary embodiments may have different size openings for one or more of the plurality of orifices 310. Smaller orifices 310 may produce a more forceful stream but can limit the volume of the water/foaming agent that can be delivered by the spray flange 222. Exemplary embodiments comprise 2-6 orifices 310, where each orifice 310 has a diameter that ranges from 0.05-.15 inches. As is illustrated, the orifices 310 are angled towards a central axis 504. The plurality of orifices 310 produces a plurality of streams of water/foaming agent. The angle of the orifices 310 toward the central axis controls the point at which the streams converge with the angle in a range of 40 degrees to 30 degrees. The illustrated angle is 40 degrees from parallel. The result of such an angle is a convergence point 318 just above the upper rim 506 of the spray flange 222. This convergence point 318 in exemplary embodiments ranges from 0.15 inches below to 0.75 inches above a plane formed by the upper rim 506 of the spray flange 222. As was noted in the discussion of FIG. 4, extension 406 positions the convergence point 318 past the openings 314 formed in the air intake portion 218 of the discharge tube 212. In an exemplary embodiment, the distance between the convergence point 318 and the center of the air intake portion 218 ranges from 0.10-.75 inches to produce an optimal amount of agitation of the water/foaming agent mixture and also to draw air into the mixture to produce an ideal amount and size of air bubbles entrapped in the foam. Having an angle of the orifices that approaches 90 degrees may increase the level of agitation but this comes at the expense of movement of the water/foaming agent mixture away from the spray flange 222 which can reduce the amount of air drawn into the intake portion 218 of the discharge tube. The result of such a reduction may be that the amount of air actually introduced into the water/foaming agent is limited such that there is a negative impact on the quantity and quality of the foam produced by the foam aspiration nozzle 210. Having an angle that approaches a direction parallel to the central axis 504 can cause a decreased level of agitation as the result of the streams slowing and thus losing energy as the streams travel farther from the upper rim 506 of the spray flange 222.

As is shown in FIG. 3A, the foam 320 moves through the discharge tube 212 in a direction away from the spray flange until the foam 320 exits from the discharge tube at an exit end 214 whereupon the foam 320 can be directed at the source of a fire and allowed to accumulate such that the foam blankets the fire to remove sources of combustion, extinguishing the fire. When in use, a user will wish to control the discharge of the foam 320 to direct the foam at a source of fire to extinguish that source. This is generally done by grasping the aspiration nozzle assembly with a hand and pointing the nozzle in the desired direction. Firefighters and others having the need to extinguish a fire often wear protective clothing, including gloves. A user wearing gloves could accidentally block, either partially or completely, the intake portion 218 of a foam aspiration nozzle 210. As described herein, exemplary embodiments include a shield 220 to help prevent such a blockage. The size of the shield portion 220 illustrated herein is exemplary. Depending upon the application, the shield portion could extend farther along the shaft portion 216 of the foam aspiration nozzle 210, could be larger in diameter, or both. Additionally the shield portion could incorporate gripping devices such as knurling, protrusion, or a combination of both.

As was noted herein, a foaming agent is added to a liquid such as water in an chamber and the chamber is pressurized such that the foaming agent/water mixture is expelled by the pressure when needed. In order to form a fire suppressant foam with the desired characteristics, the ratio of foaming agent to a water must be maintain at a desired level. Generally water is added to a extinguisher chamber and a foaming agent is measured into the chamber. Measuring the foaming agent is easily done with a measuring cup or calibrated bucket. Measuring the amount of water added is more difficult. In an exemplary embodiment, a measurement line 110 as illustrated in FIG. 1 is formed on the shaft portion 216 of the foam aspiration nozzle 210. This measurement line can be used to determine the level of water added to an extinguisher chamber by placing the shaft portion 216 of the foam aspiration nozzle 210 into the extinguisher chamber and observing the level of water on the shaft portion after it is removed from the chamber. In an exemplary embodiment, the measurement line 110 is located such that a water level located at the measurement line 110 would result in the correct ration when mixed with a measured amount of foaming agent.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

Any implementation or embodiment disclosed herein can be combined with any other implementation or embodiment, and references to “an implementation,” “some implementations,” “one implementation,” “an embodiment,” “some embodiments,” “certain embodiments,” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation or embodiment can be combined with any other implementation or embodiment, inclusively or exclusively, in any manner consistent with the aspects and implementations disclosed herein.

Where technical features in the drawings, detailed description or any claim are followed by reference numbers, the reference numbers have been included to increase the intelligibility of the drawings, detailed description, and claims. Accordingly, neither the reference numbers nor their absence have any limiting effect on the scope of any claim elements.

Coupled elements can be electrically, magnetically, mechanically, or physically coupled with one another directly or with intervening elements. The scope of the systems and methods described herein is thus indicated by the appended claims, rather than the foregoing description, and changes that come within the meaning and range of equivalency of the claims are embraced therein.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes, and proportions of the various elements, values of parameters, mounting arrangements, use of materials, colors, and orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the Figures. The orientation of various elements may differ according to other exemplary embodiments, and that such variations are intended to be encompassed by the present disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

What is claimed is:

1. A device for the production of firefighting foam, the device comprising:
an attachment portion in fluid communication with an inlet tube;
a plurality of outlet orifices located in a spray flange and in fluid communication with the inlet tube;
the plurality of outlet orifices being located adjacent to an outlet recess;
a wand portion having a first end and a second end, the wand portion comprising air inlets adjacent to the first end and a foam outlet at the second end, when the wand portion is affixed to the spray flange, the plurality of outlet orifices are located adjacent to the air inlets; and
the plurality of outlet orifices aligned such that their alignments converge at a point located outside of a spatial area formed by the outlet recess.

2. The device of claim 1, wherein the outlet recess is a concave recess.

3. The device of claim 1, wherein the number of outlet orifices is greater than 2.

4. The device of claim 3, wherein the diameter of the outlet orifices ranges from 0.085 inches to 0.1 inches.

5. The device of claim 1, wherein the wand portion is a tubular shape and the outlet orifices are positioned in an inner diameter of the wand portion at a point farther from the first end of the wand portion than the air inlets.

6. The device of claim 5, wherein a centerline of the outlet orifices intersects the centerline of the outlet recess at an angle greater than 30 degrees.

7. The device of claim 1, further comprising a shield portion surrounding the air inlets.

8. A fire extinguisher foam generating device, the device comprising:
a spray flange comprising an input, a plurality of outlet orifices in fluid communication with the input, the plurality of outlet orifices arranged about a central axis, each orifice arranged such that a stream passing through the orifice converges at a point on a line extending along the central axis of the spray flange;
a tubular wand comprising a flange mating surface at a first end of the wand, the mating surface adapted to receive the spray flange, the wand comprising a plurality of air inputs located adjacent to the receiver, and an outlet at a second end of the wand;
a shield portion having an open first end and an opening formed in a second end, the spray flange passing through the opening formed in the second end and affixed to the first end of the wand using the receiver, the shield portion captured between the spray flange and the receiver portion of the wand.

9. The device of claim 8, wherein the spray flange comprises an outlet recess in which an exit end of the outlet orifices is located, the outlet recess being symmetrically arranged about the central axis of the spray flange.

10. The device of claim 9, wherein the outlet recess is concave in shape.

11. The device of claim 8, wherein the outlet orifices have a diameter between 0.085 and 0.1 inches.

12. The device of claim 11, wherein there are at least 2 outlet orifices.

13. The device of claim 8, wherein a centerline of each outlet orifice intersects a centerline extending through the central axis of the spray flange at an angle greater than 30 degrees and less than 40 degrees.

14. The device of claim 8, wherein the number of air inputs is greater than 2 and each air input is chamfered such that an opening at an inner surface of the wand has a greater surface area than a corresponding opening at an outer surface of the wand.

15. The device of claim 8, wherein the outlet orifices are positioned in an inner diameter of the wand portion at a point farther from the first end of the wand than the air inputs.

16. A method of producing firefight foam comprising the steps of:
providing a water and foaming agent mixture;
pressurizing the water and foaming agent mixture such that it passes through a spray flange comprising a plurality of orifices, the water and foaming agent mixture directed through the orifices to form a plurality of streams;
aligning the plurality of orifices such that the streams of water and foaming agent converge at a point above the spray flange inside a wand portion, the point along an axial centerline of the spray flange, the wand portion having a tubular structure with the spray flange positioned at a first end and having an exit port at a second end;
introducing air to the converging streams of water and foaming agent from air inlets formed in sidewalls of the wand portion such that the water and foaming agent is converted to foam inside the wand portion; and
expelling the foam from the exit port of the wand portion.

17. The method of claim 16, wherein the spray flange comprises a concave recess through which the plurality of orifices direct the streams of water and foaming agent.

18. The method of claim 16, wherein the air inlets are located proximately to a first end of the wand portion with the streams of water and foaming agent converge at a point farther from the first end of the wand portion than the location of the air inlets.

19. The method of claim 16, in which the expelled foam is directed from the exit port by gripping a shield portion that surrounds the air inlets and pointing the exit port in a desired direction.

20. A device for the production of firefighting foam, the device comprising:
an attachment portion in fluid communication with an inlet tube;
at least 2 outlet orifices each having a diameter ranging from 0.085 to 0.1 inches and located in a spray flange, the spray flange in fluid communication with the inlet tube;
the at least 2 outlet orifices being located adjacent to a concave outlet recess;
a tubular wand portion having a first end and a second end, the wand portion comprising air inlets adjacent to the first end and a foam outlet at the second end, a shield portion surrounding the air inlets;
when the wand portion is affixed to the spray flange, the plurality of outlet orifices being located adjacent to the air inlets with the air inlets located closer to the first end of the tubular wand portion than the outlet orifices; and
the plurality of outlet orifices aligned such that their alignments converge at a point located outside of a spatial area formed by the outlet recess.
